(19) United States
(12) Patent Application Publication
(10) Pub. No.: US 2026/0012102 A1
(43) Pub. Date: Jan. 8, 2026

(54) POWER CONVERTER

(71) Applicant: DENSO CORPORATION, Kariya-city (JP)

(72) Inventors: Shintaro KOGURE, Kariya-city (JP); Takaaki KITAMORI, Kariya-city (JP)

(73) Assignee: DENSO CORPORATION, Kariya-city (JP)

(21) Appl. No.: 19/256,921

(22) Filed: Jul. 1, 2025

Related U.S. Application Data
(63) Continuation of application No. PCT/JP2023/044022, filed on Dec. 8, 2023.

(30) Foreign Application Priority Data
Feb. 8, 2023 (JP) 2023-017842

(51) Int. Cl. H02M 7/00; H02M 7/537

(52) U.S. Cl. CPC H02M 7/003; H02M 7/537

(57) ABSTRACT

A power converter includes an inverter to convert electric power from a battery, a smoothing capacitor to smooth electric current, and a Y-capacitor with a Y-capacitor element to reduce noise. These components are housed in a case with a frame that opens in one direction and has a ring shape. The case features a partition wall that divides the storage space into two spaces. The inverter and smoothing capacitor are located in the first storage space, while the Y-capacitor is in the second storage space. The electrical component and the Y-capacitor are positioned such that they do not overlap in the one direction.

### CROSS REFERENCE TO RELATED APPLICATIONS

The present application is a continuation application of International Patent Application No. PCT/JP2023/044022 filed on Dec. 8, 2023, which designated the U.S. and claims the benefit of priority from Japanese Patent Application No. 2023-017842 filed on Feb. 8, 2023. The entire disclosures of all of the above applications are incorporated herein by reference.

### TECHNICAL FIELD

The present disclosure relates to a power converter.

### BACKGROUND

A conventional power converter includes a switching element, a smoothing capacitor, and a Y-capacitor for reducing noise generated by the switching element.

### SUMMARY

According to at least one embodiment, a power converter includes an inverter to convert electric power supplied from a battery. The power converter also has a smoothing capacitor to smooth electric current supplied from the battery. Additionally, the power converter includes a Y-capacitor with a Y-capacitor element to reduce noise. A case houses the inverter, the smoothing capacitor, and the Y-capacitor. The case may have a frame that opens in one direction and have a ring shape. There may be also a partition wall that divides a storage space surrounded by the frame into two spaces in the one direction. The partition wall and a part of the frame define a first storage space. The partition wall and another part of the frame define a second storage space. An electrical component including the inverter and the smoothing capacitor may be provided in the first storage space. The Y-capacitor may be provided in the second storage space. The electrical component and the Y-capacitor may be shifted in a planar direction perpendicular to the one direction so that the electrical component and the Y-capacitor do not overlap in the one direction.

### BRIEF DESCRIPTION OF DRAWINGS

The details of one or more embodiments are set forth in the accompanying drawings and the description below. Other features and advantages will be apparent from the description and drawings, and from the claims.

FIG. 1 is an electrical circuit diagram of a power converter.

FIG. 2 is a plan view of the power converter as viewed from a first storage space.

FIG. 3 is a plan view of the power converter as viewed from a second storage space.

FIG. 4 is a cross-sectional view taken along IV-IV line of FIG. 3.

FIG. 5 is an exploded perspective view for explaining arrangement of a Y-capacitor in the second storage space.

FIG. 6 is a perspective view for explaining the arrangement of the Y-capacitor in the second storage space.

FIG. 7 is a perspective view of the Y-capacitor.

FIG. 8 is a cross-sectional view of the Y-capacitor taken along VII-VII line in FIG. 7.

FIG. 9 is a cross-sectional view of the Y-capacitor taken along IX-IX line in FIG. 7.

FIG. 10 is a cross-sectional view illustrating a modification of a Y-capacitor.

### DETAILED DESCRIPTION

To begin with, examples of relevant techniques will be described.

A power converter according to a comparative example includes a switching element, a smoothing capacitor, a Y-capacitor for reducing noise generated by the switching element, and a housing for accommodating these elements.

The housing accommodates the switching element, the smoothing capacitor, and the Y-capacitor in the same internal space. As a result, heat is easily transferred from the switching elements and smoothing capacitor to the Y-capacitor. Therefor, the Y-capacitor may become very hot.

In contrast to the comparative example, according to a power converter of the present disclosure, overheating of a Y-capacitor can be reduced.

According to one aspect of the present disclosure, a power converter includes an inverter to convert electric power supplied from a battery. The power converter also has a smoothing capacitor to smooth electric current supplied from the battery. Additionally, the power converter includes a Y-capacitor with a Y-capacitor element to reduce noise. A case houses the inverter, the smoothing capacitor, and the Y-capacitor. The case has a frame that opens in one direction and has a ring shape. There is also a partition wall that divides a storage space surrounded by the frame into two spaces in the one direction. The partition wall and a part of the frame define a first storage space. The partition wall and another part of the frame define a second storage space. An electrical component including the inverter and the smoothing capacitor is provided in the first storage space. The Y-capacitor is provided in the second storage space. The electrical component and the Y-capacitor are shifted in a planar direction perpendicular to the one direction so that the electrical component and the Y-capacitor do not overlap in the one direction.

As a result, transfer of heat from the electrical component to the Y-capacitor element can be reduced. Overheating of the Y-capacitor element can be reduced.

The following will describe embodiments for carrying out the present disclosure with reference to the drawings. In each embodiment, parts corresponding to the elements described in the preceding embodiments are denoted by the same reference numerals, and redundant explanation may be omitted. When only a part of a configuration is described in an embodiment, another preceding embodiment may be applied to the other parts of the configuration.

It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

### <In-Vehicle System>

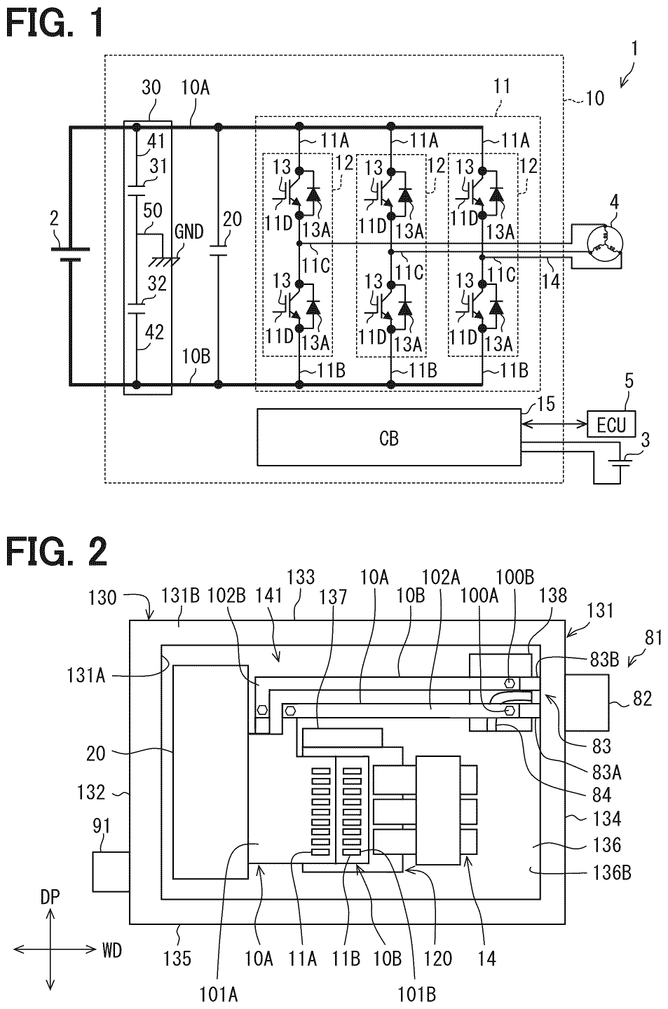

FIG. 1 is an electric circuit diagram of a power converter 10 mounted on an in-vehicle system 1. The in-vehicle system 1 has a high-voltage battery 2, a low-voltage battery 3, a motor generator 4, a controller 5, and the power converter 10. A vehicle on which the in-vehicle system 1 is mounted is a hybrid vehicle that can run by switching between and/or combining driving force of an engine and the driving force of the motor generator 4.

The power converter 10 includes high-voltage wires 10A, 10B, an inverter 11, a control circuit board 15, a smoothing capacitor 20, a Y-capacitor 30, a high-voltage connector 81, and a low-voltage connector 91. A high-voltage wire 10A is a wiring connected to a positive electrode of the high-voltage battery 2. The high-voltage wire 10A may be referred to as a P-side high-voltage wire 10A. A high-voltage wire 10B is a wiring connected to a negative electrode of the high-voltage battery 2. The high-voltage wire 10B may be referred to as an N-side high-voltage wire 10B. The inverter 11 and the smoothing capacitor 20 may be referred to as electrical components. The electrical components include the inverter 11 and the smoothing capacitor 20.

The inverter 11 is connected to the P-side high-voltage wire 10A and the N-side high-voltage wire 10B. The inverter 11 includes multiple semiconductor modules 12. A semiconductor module 12 includes two switching elements 13 and two diodes 13A. The two switching elements 13 are connected in series between the P-side high-voltage wire 10A and the N-side high-voltage wire 10B.

A P-side input terminal 11A connected to the high-voltage battery 2 is connected to a collector electrode of one of the two switching elements 13 provided on the P-side. An N-side input terminal 11B connected to the high-voltage battery 2 is connected to one emitter of the two switching elements 13 provided on the N-side. An anode of a diode 13A is connected to the emitter of the corresponding switching element 13. A cathode of the diode 13A is connected to the collector of the corresponding switching element 13.

A motor terminal 11C connected to the motor generator 4 is connected to the emitter of the P-side switching element 13 and the collector of the N-side switching element 13. The multiple switching elements 13 convert DC power supplied from the high-voltage battery 2 into AC power that can drive the motor generator 4. The converted electric power is supplied to the motor generator 4 via a connecting busbar 14.

The control circuit board 15 controls on/off of the multiple switching elements 13 using operating power supplied from the low-voltage battery 3. A control circuit for controlling the on/off of the multiple switching elements 13 is mounted on the control circuit board 15. Connection terminals 11D of the multiple switching elements 13 are connected to the control circuit board 15 by soldering. The connection terminals 11D of the multiple switching elements 13 are electrically connected to the control circuit.

The smoothing capacitor 20 mainly smoothens the DC voltage supplied from the high-voltage battery 2. The smoothing capacitor 20 is connected to the P-side high-voltage wire 10A and the N-side high-voltage wire 10B. The smoothing capacitor 20 is connected in parallel to the inverter 11. The high-voltage wires 10A, 10B electrically connect the inverter 11, the smoothing capacitor 20, and the high-voltage battery 2 together.

The Y-capacitor 30 mainly removes noise components leaking from the inverter 11. The Y-capacitor 30 has two Y-capacitor elements 31, 32, two Y-capacitor busbars 41, 42, and a GND busbar 50. The two Y-capacitor elements 31, 32 are connected in series to the P-side high-voltage wire 10A and the N-side high-voltage wire 10B via the two Y-capacitor busbars 41, 42.

One of the two Y-capacitor elements 31, 32 provided on the P-side high-voltage wire 10A, may be referred to as a P-side Y-capacitor element 31. One of the two Y-capacitor busbars 41, 42 provided on the P-side Y-capacitor element 31, may be referred to as a P-side Y-capacitor busbar 41. The P-side Y-capacitor busbar 41 has a P-side first busbar terminal 41A connected to the P-side Y-capacitor element 31, and a P-side second busbar terminal 41B connected to the P-side high-voltage wire 10A. The P-side Y-capacitor element 31 is electrically connected to the P-side high-voltage wire 10A via the P-side Y-capacitor busbar 41.

Similarly, one of the two Y-capacitor elements 31, 32 provided on the N-side high-voltage wire 10B, may be referred to as an N-side Y-capacitor element 32. One of the two Y-capacitor busbars 41, 42 provided on the N-side Y-capacitor element 32, may be referred to as an N-side Y-capacitor busbar 42. The N-side Y-capacitor busbar 42 has an N-side first busbar terminal 42A connected to the N-side Y-capacitor element 32, and an N-side second busbar terminal 42B connected to the N-side high-voltage wire 10B. The N-side Y-capacitor element 32 is electrically connected to the N-side high-voltage wire 10B via the N-side Y-capacitor busbar 42.

The GND busbar 50 has a P-side GND terminal 51, an N-side GND terminal 52, and a case connecting portion 54 that is connected to a case 130. The P-side GND terminal 51 is connected to the P-side Y-capacitor element 31. The N-side GND terminal 52 is connected to the N-side Y-capacitor element 32. The GND busbar 50 extends to connect the P-side GND terminal 51, the N-side GND terminal 52, and the case connecting portion 54. It can also be said that the GND busbar 50 has the P-side GND terminal 51, the N-side GND terminal 52, and an extension portion 53 connecting these together. The extension portion 53 can also be said to have the case connecting portion 54.

The P-side Y-capacitor element 31 and the N-side Y-capacitor element 32 are electrically and thermally connected via the GND busbar 50. The GND busbar 50 is connected to the Y-capacitor elements 31, 32 and is electrically and thermally connected to a housing of the power converter 10.

The GND busbar 50 is electrically connected to a body ground such as a chassis via the case 130. The Y-capacitor elements 31, 32 direct noise components leaking from the inverter 11 to the body ground via the GND busbar 50. This removes noise components from the inverter 11. Furthermore, the Y-capacitor elements 31, 32 can remove not only the noise components leaking from the inverter 11 but also the noise components flowing through the high-voltage wires 10A, 10B.

The high-voltage connector 81 is a supply port through which high-voltage power is supplied from the high-voltage battery 2. The high-voltage wires 10A, 10B and the Y-capacitor busbars 41, 42 are electrically connected to the high-voltage connector 81. High voltage power is supplied from the high-voltage battery 2 to the inverter 11, the smoothing capacitor 20, and the Y-capacitor 30 via the high-voltage connector 81. In addition to the high-voltage battery 2, a signal wire 84 for transmitting an interlock signal is connected to the high-voltage connector 81. One end of the signal wire 84 is connected to the high-voltage connector 81, and the other end is connected to the control circuit board 15. The high-voltage wires 10A, 10B may be referred to as first wires. The Y-capacitor busbars 41, 42 may be referred to as second wires.

The low-voltage connector 91 is a supply port through which low-voltage power is supplied from the low-voltage battery 3. The control circuit board 15 is electrically connected to the low-voltage connector 91. A low-voltage power is supplied from the low-voltage battery 3 to the control circuit board 15 via the low-voltage connector 91. In addition to the low-voltage battery 3, the low-voltage connector 91 is electrically connected to the controller 5 as a host ECU, for example. A control circuit mounted on the control circuit board 15 cooperates with the controller 5 to control the inverter 11 and auxiliary devices included in the vehicle.

### <Mechanical Configuration of Power Converter>

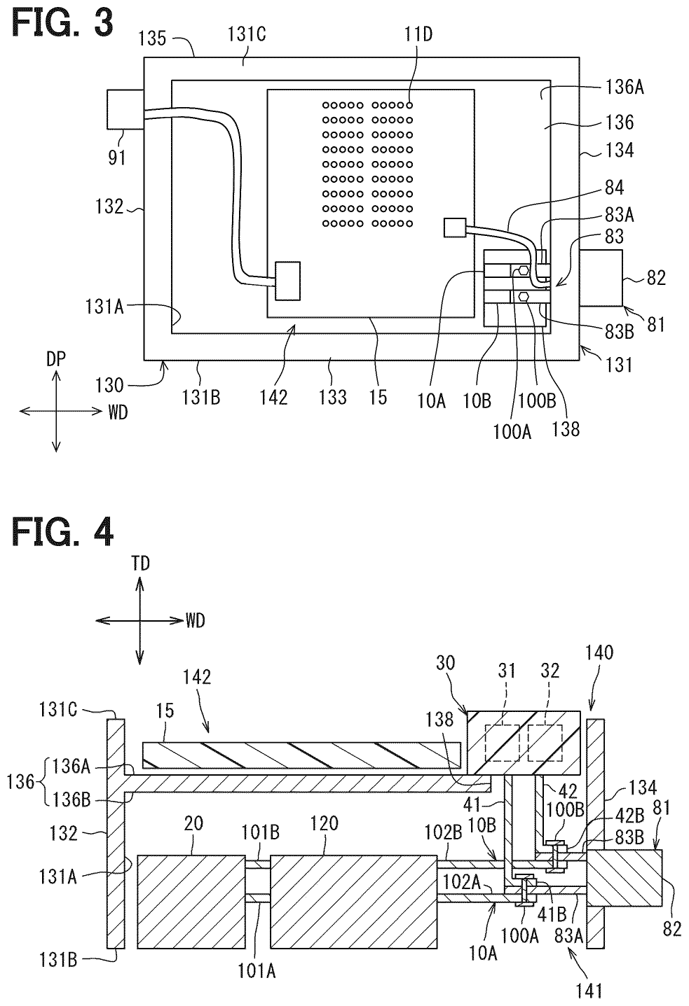

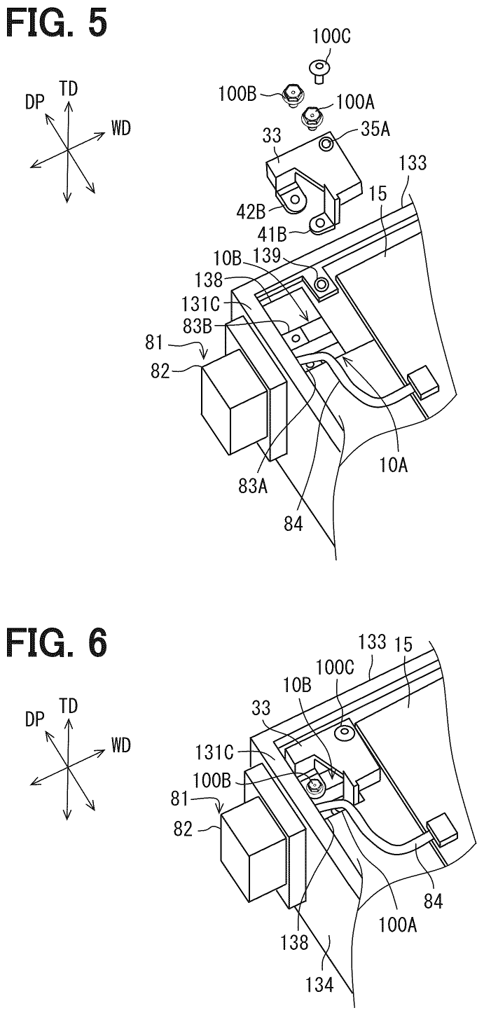

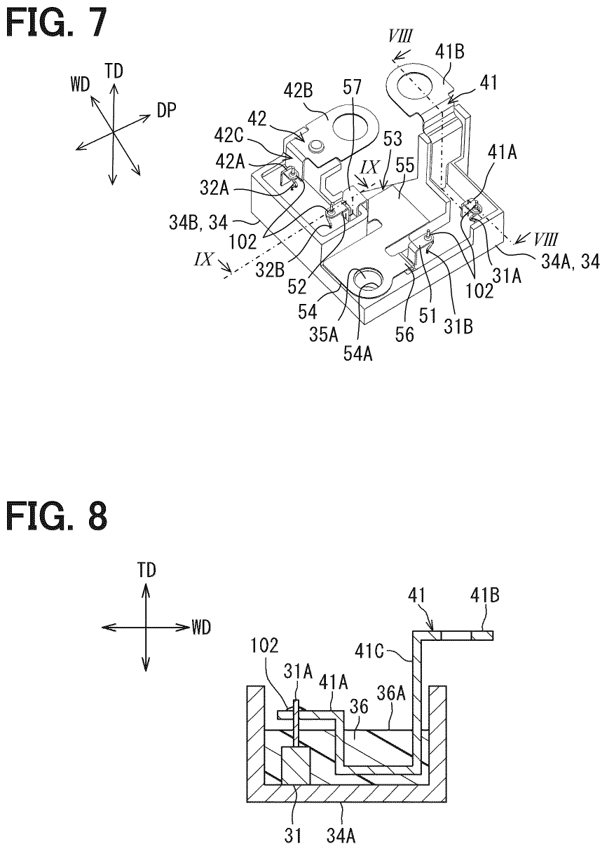

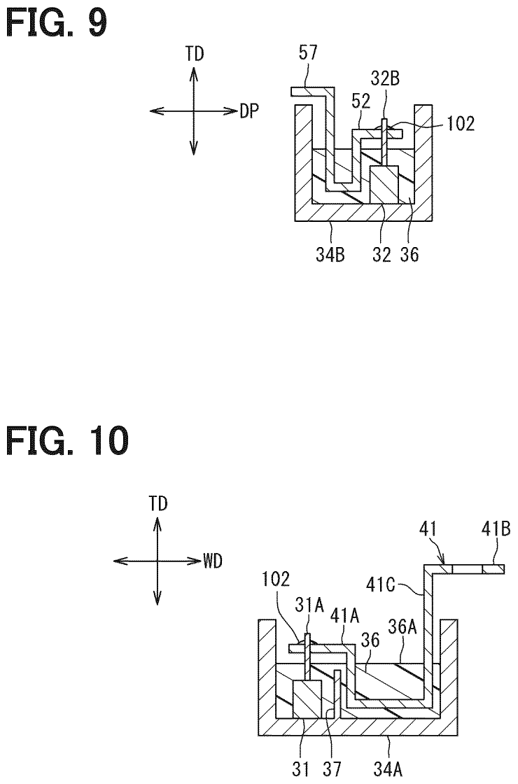

Before describing a mechanical configuration of the power converter 10, the drawings will be described. FIG. 2 is a plan view of the power converter 10 as viewed from a first storage space 141. FIG. 3 is a plan view of the power converter 10 as viewed from a second storage space 142. FIG. 4 is a cross-sectional view taken along IV-IV line of FIG. 3. FIG. 5 is an exploded perspective view for explaining arrangement of the Y-capacitor 30 in the second storage space 142. FIG. 6 is a perspective view for explaining arrangement of the Y-capacitor 30 in the second storage space 142. FIG. 7 is a perspective view of the Y-capacitor 30. FIG. 8 is a cross-sectional view of the Y-capacitor taken along line VIII-VIII shown in FIG. 7. FIG. 9 is a cross-sectional view of the Y-capacitor taken along line IX-IX shown in FIG. 7.

In the present embodiment, as an example, of the two high-voltage wires 10A, 10B, one provided on a first opening 131B side is described as the P-side high-voltage wire 10A. The one provided on a second opening 131C side is described as the N-side high-voltage wire 10B. However, the P-side high-voltage wire 10A and the N-side high-voltage wire 10B are not limited to this. Of the two high-voltage wires 10A, 10B, the one provided on the first opening 131B side may be regarded as the N-side high-voltage wire 10B. The one provided on the second opening 131C side may be regarded as the P-side high-voltage wire 10A. The configuration described below is merely one example of the present embodiment.

Next, a mechanical configuration of the power converter 10 will be described. In addition to the components described above, the power converter 10 has the following elements. The power converter 10 includes a cooler 110 and the case 130. The semiconductor modules 12 and the cooler 110 constitute a power module 120. The cooler 110 has a layered cooling structure. The cooler 110 includes a supply pipe 111, a discharge pipe 113, and relay pipes 112. The relay pipes 112 are arranged in a ladder-like manner between the supply pipe 111 and the discharge pipe 113. The supply pipe 111 and the discharge pipe 113 are connected via the relay pipes 112 in a manner that allows coolant to flow therethrough.

The semiconductor modules 12 are individually housed between the adjacent relay pipes 112. The semiconductor module 12 is sandwiched between the adjacent relay pipes 112. The semiconductor module 12 is housed in the cooler 110 to form the power module 120. The heat of the semiconductor module 12 is easily dissipated to the relay pipe 112 efficiently. The cooler 110 is fixed to the case 130. Since the coolant flows inside the cooler 110, the temperature of the cooler 110 is low. Since the case 130 is fixed to the cooler 110, the temperature of the case 130 is also low.

### <Case>

The case 130 forms a part of a container. The case 130 is made of a metal material. The case 130 is formed by, for example, aluminum die casting. The case 130 includes a frame 131 and a partition wall 136. The frame 131 extends in a first direction and has a closed annular enclosure shape centered on an axis along the first direction. The frame 131 has two ends spaced apart in the first direction. One end of the frame 131 defines the first opening 131B that opens in the first direction. Another end of the frame 131 defines the second opening 131C that opens in a width direction. As an example, the first opening 131B is provided lower than the second opening 131C in the gravity direction.

The partition wall 136 is provided inside the frame 131 and divides a storage space 140 inside the frame 131 into two spaces. The partition wall 136 has a flat shape with a small thickness in one direction. The partition wall 136 has a front surface 136A aligned in one direction and a back surface 136B on a rear side thereof. The surface 136A is provided on the second opening 131C side. The back surface 136B is provided on the first opening 131B side.

In addition, since the one direction coincides with a plate thickness direction of the partition wall 136, it may be referred to as a thickness direction TD. A depth direction perpendicular to the thickness direction TD may be referred to as a depth direction DP. A width direction perpendicular to the thickness direction TD and the depth direction DP may be referred to as a width direction WD. A direction perpendicular to the thickness direction TD may be referred to as a planar direction. The planar direction is a direction along the width direction WD and the depth direction DP.

The frame 131 has two walls spaced apart from each other in the width direction WD and two walls spaced apart from each other in the depth direction DP. The frame 131 includes a first wall portion 132 and a third wall portion 134 that are spaced apart from each other in the width direction WD, and a second wall portion 133 and a fourth wall portion 135 that are spaced apart from each other in the depth direction DP. The first wall portion 132 to the fourth wall portion 135 are arranged in order in a clockwise direction. The first wall portion 132 to the fourth wall portion 135 are integrally connected to form the frame 131.

The partition wall 136 is provided on an inner surface 131A of the frame 131 to divide the storage space 140 in the thickness direction TD. The storage space 140 is divided into the first storage space 141 and the second storage space 142 by the partition wall 136. The first storage space 141 is defined by a portion of the frame 131 on the side of the first opening 131B and the rear surface 136B of the partition wall 136. The second storage space 142 is defined by a portion of the frame 131 on the second opening 131C side and the surface 136A of the partition wall 136.

The partition wall 136 is provided with through holes 137 for passing the connection terminals 11D extending from the semiconductor module 12 therethrough, and a wiring hole 138 for passing the signal wire 84 therethrough. In addition to passing the signal wire 84 through the wiring hole 138, the wiring hole 138 also serves the following object. The wiring hole 138 is adapted to receive a tool for mechanically connecting the electrical components housed in the first storage space 141 and the electrical components housed in the second storage space 142.

The through holes 137 and the wiring hole 138 are holes that penetrate the partition wall 136 in the thickness direction TD. As an example, the through holes 137 are provided at approximately a center of the partition wall 136 in the width direction WD. The wiring hole 138 is provided at a position closer to the third wall portion 134 than the through holes 137.

Furthermore, the high-voltage connector 81 is provided on the third wall portion 134. The high-voltage connector 81 has a supply portion 82 and a distribution portion 83. The supply portion 82 is a portion to which high voltage power is supplied from the high-voltage battery 2. The distribution portion 83 is a portion where power is distributed to the high-voltage wires 10A, 10B and the Y-capacitor busbars 41, 42. A portion of the distribution portion 83 connected to the P-side high-voltage wire 10A and the P-side Y-capacitor busbar 41 may be referred to as a P-side distribution portion 83A. A portion of the distribution portion 83 that is connected to the N-side high-voltage wire 10B and the N-side Y-capacitor busbar 42 may be referred to as an N-side distribution portion 83B. The P-side high-voltage wire 10A, the P-side Y-capacitor busbar 41, and the P-side distribution portion 83A are electrically and mechanically connected together via a P-side fastening member 100A. The N-side high-voltage wire 10B, the N-side Y-capacitor busbar 42, and the N-side distribution portion 83B are connected electrically and mechanically via an N-side fastening member 100B.

The supply portion 82 is attached to the third wall portion 134. The distribution portion 83 extends in the width direction WD in the first storage space 141 so as to move away from the third wall portion 134. The P-side distribution portion 83A and the N-side distribution portion 83B extend in the width direction WD in the first storage space 141 so as to move away from the third wall portion 134. The wiring hole 138 is formed in the partition wall 136 so as to be adjacent to a portion of the third wall portion 134 where the high-voltage connector 81 is provided. The wiring hole 138 further overlaps with the P-side fastening member 100A and the N-side fastening member 100B in the thickness direction TD.

In the first storage space 141, the high-voltage wires 10A, 10B, the smoothing capacitor 20, and the power module 120 are stored. The connection terminal 11D of the semiconductor module 12 extends from the through holes 137 toward the second storage space 142. The control circuit board 15 and the Y-capacitor 30 are housed in the second storage space 142. The control circuit board 15 is attached to the partition wall 136 so that a portion of the control circuit board 15 overlaps with the through holes 137. The first storage space 141 may be referred to as a high voltage area because it is an area in which high voltage components to which high voltage power is supplied from the high-voltage battery 2 are stored. The second storage space 142 may be referred to as a low-voltage area because it is an area in which low-voltage components to which low-voltage power is supplied from the low-voltage battery 3 are stored.

The Y-capacitor 30 is provided in the second storage space 142 so that the Y-capacitor busbars 41, 42 pass through the wiring hole 138. The Y-capacitor 30 is attached to a side of the wiring hole 138 in the partition wall 136 so that the Y-capacitor busbars 41, 42 pass through the wiring hole 138. The P-side Y-capacitor element 31 and the N-side Y-capacitor element 32 are housed in the second storage space 142. The Y-capacitor busbars 41, 42 extend through the wiring hole 138 from the second storage space 142 to the first storage space 141. Further, a fastening hole 139 to which the GND busbar 50 is fastened is provided near the wiring hole 138 in the partition wall 136. The GND busbar 50 is fastened to the fastening hole 139 via the fastening member 100C, whereby the Y-capacitor elements 31, 32 are electrically connected to the case 130. The Y-capacitor elements 31, 32 are electrically connected to a body ground such as a chassis via the case 130.

The power module 120 is provided at approximately a center of the first storage space 141 in the width direction WD. The power module 120 is provided on the fourth wall portion 135 side in the depth direction DP. The smoothing capacitor 20 is provided at a position closer to the first wall portion 132 than the power module 120 in the width direction WD. The smoothing capacitor 20 is provided across from the second wall portion 133 to the fourth wall portion 135 in the depth direction DP. Furthermore, the high-voltage connector 81 is provided on the third wall portion 134. The high-voltage connector 81 is provided at a position closer to the second wall portion 133 than the power module 120 in the depth direction DP.

As described above, the wiring hole 138 is provided adjacent to the portion of the third wall portion 134 where the high-voltage connector 81 is provided. The Y-capacitor 30 is provided in the second storage space 142 so as to cover the wiring hole 138. Hereinafter, the Y-capacitor 30 may simply be referred to as being provided in the wiring hole 138. The Y-capacitor 30 is attached to a side of the wiring hole 138 in the partition wall 136 so that the Y-capacitor busbars 41, 42 pass through the wiring hole 138.

In relation to the width direction WD, the wiring hole 138 and the Y-capacitor 30 are provided at a position closer to the third wall portion 134 than the smoothing capacitor 20 and the power module 120. The Y-capacitor 30 does not overlap with the smoothing capacitor 20 and the power module 120 in the thickness direction TD. The Y-capacitor 30 is arranged offset in the planar direction with respect to the smoothing capacitor 20 and the power module 120.

The P-side high-voltage wire 10A has a P-side capacitor busbar 101A and a P-side connector busbar 102A. The P-side capacitor busbar 101A connects the P-side input terminal 11A of the power module 120 and the smoothing capacitor 20. The P-side connector busbar 102A connects the power module 120 and the P-side distribution portion 83A of the high-voltage connector 81. The P-side capacitor busbar 101A extends in the width direction WD between the smoothing capacitor 20 and the power module 120. The P-side capacitor busbar 101A has a flat portion and a protruding portion. The flat portion extends in the width direction WD and connects the P-side input terminal 11A and the smoothing capacitor 20. The protruding portion protrudes from the flat portion toward the second wall portion 133.

The P-side connector busbar 102A connects a portion of the P-side capacitor busbar 101A that protrudes toward the second wall portion 133 and the P-side distribution portion 83A. The P-side connector busbar 102A extends between them in the width direction WD. The P-side second busbar terminal 41B, the P-side connector busbar 102A, and the P-side distribution portion 83A are fastened at a position overlapping with the wiring hole 138 of the first storage space 141 in the thickness direction TD. These are electrically and mechanically connected via the P-side fastening member 100A.

The N-side high-voltage wire 10B has an N-side capacitor busbar 101B and an N-side connector busbar 102B. The N-side capacitor busbar 101B connects the N-side input terminal 11B of the power module 120 and the smoothing capacitor 20. The N-side connector busbar 102B connects the power module 120 and the N-side distribution portion 83B of the high-voltage connector 81. The N-side capacitor busbar 101B extends in the width direction WD between the smoothing capacitor 20 and the power module 120. The N-side capacitor busbar 101B has a flat portion and a protruding portion. The flat portion extends in the width direction WD and connects the N-side input terminal 11B and the smoothing capacitor 20. The protruding portion protrudes from the flat portion toward the second wall portion 133.

The N-side connector busbar 102B extends in the width direction WD between a portion of the N-side capacitor busbar 101B that protrudes toward the second wall portion 133 and the N-side distribution portion 83B. The N-side second busbar terminal 42B, the N-side connector busbar 102B, and the N-side distribution portion 83B are fastened at a position overlapping with the wiring hole 138 of the first storage space 141 in the thickness direction TD. These are electrically and mechanically connected via the N-side fastening member 100B.

### <Mechanical Configuration of Y-Capacitor>

The Y-capacitor 30 further includes a Y-capacitor case 33 and a coating resin 36. The Y-capacitor case 33 holds and houses the Y-capacitor elements 31, 32, the Y-capacitor busbars 41, 42, and the GND busbar 50. The Y-capacitor case 33 includes two element storage portions 34 for housing the Y-capacitor elements 31, 32 respectively, and a connecting portion 35 for holding the GND busbar 50. The element storage portions 34 have a box shape with a bottom that is open on one end in the thickness direction TD. The two element storage portions 34 are connected via the connecting portion 35. The connecting portion 35 has a flat shape extending in a planar direction.

The element storage portion 34 housing the P-side Y-capacitor element 31 may be referred to as a P-type element storage portion 34A. The P-side Y-capacitor element 31, a portion of the P-side Y-capacitor busbar 41, and a portion of the GND busbar 50 are provided in the P-type element storage portion 34A. The P-type element storage portion 34A is filled with the coating resin 36. The P-side Y-capacitor element 31, a portion of the P-side Y-capacitor busbar 41, and a portion of the GND busbar 50 are covered with the coating resin 36. The P-side first busbar terminal 41A, the P-side second busbar terminal 41B, and the P-side GND terminal 51 are exposed from an exposed surface 36A of the coating resin 36.

The P-side Y-capacitor busbar 41 has a main portion 41C, a P-side first busbar terminal 41A, and a P-side second busbar terminal 41B. The main portion 41C has a portion extending in the planar direction along the bottom surface of the P-type element storage portion 34A, and a portion extending in the thickness direction TD. The main portion 41C has two portions extending in the thickness direction TD. The two portions extending in the thickness direction TD are provided at both ends in the width direction WD of a portion extending in the planar direction along the bottom surface of the P-type element storage portion 34A.

The P-side first busbar terminal 41A is provided at an end of one of the portions extending in the thickness direction TD. The P-side second busbar terminal 41B is provided at another end of the portions extending in the thickness direction TD. The P-side first busbar terminal 41A and the P-side second busbar terminal 41B both extend along the planar direction. The P-side Y-capacitor busbar 41 has a substantially U-shape when viewed in the depth direction DP. A recessed portion of the U-shape is covered with the coating resin 36 and is fixed to an inner surface of the P-type element storage portion 34A.

The coating resin 36 coats a portion extending in the planar direction along the bottom surface of the P-type element storage portion 34A and parts of two portions extending in the thickness direction TD. The remainder of the two portions extending in the thickness direction TD from the exposed surface 36A of the coating resin 36, as well as the P-side first busbar terminal 41A and the P-side second busbar terminal 41B, are exposed.

The P-side Y-capacitor element 31 includes a P-side first element terminal 31A connected to the P-side first busbar terminal 41A, and a P-side second element terminal 31B connected to the P-side GND terminal 51. The P-side first element terminal 31A and the P-side second element terminal 31B extend in the thickness direction TD so as to move away from the P-side Y-capacitor element 31. An end of the P-side first element terminal 31A and an end of the P-side second element terminal 31B are exposed from the exposed surface 36A.

The P-side first element terminal 31A exposed from the exposed surface 36A and the P-side first busbar terminal 41A are connected via solder 102. The P-side second element terminal 31B exposed from the exposed surface 36A is connected to the P-side GND terminal 51 via solder 102. The P-side GND terminal 51 is provided at a position closer to the first opening end than the exposed surface 36A. It can also be said that the P-side first busbar terminal 41A is provided closer to the first storage space 141 than exposed surface 36A. It can also be said that the P-side GND terminal 51 is provided closer to the first storage space 141 than the exposed surface 36A.

The P-side Y-capacitor busbar 41 is solder-connected to the P-side first element terminal 31A outside the coating resin 36. The P-side Y-capacitor busbar 41 extends from a connecting portion with the P-side first element terminal 31A toward a connecting portion with the P-side high-voltage wire 10A. The P-side Y-capacitor busbar 41 is arranged so that a part of its length is covered with the coating resin 36.

The element storage portion 34 housing the N-side Y-capacitor element 32 may be referred to as an N-type element storage portion 34B. The N-type element storage portion 34B is provided with the N-side Y-capacitor element 32, a portion of the N-side Y-capacitor busbar 42, and a portion of the GND busbar 50. The N-type element storage portion 34B is filled with the coating resin 36. The N-side Y-capacitor element 32, a portion of the N-side Y-capacitor busbar 42, and a portion of the GND busbar 50 are covered with the coating resin 36. The N-side first busbar terminal 42A, the N-side second busbar terminal 42B, and the N-side GND terminal 52 are exposed from the exposed surface 36A of the coating resin 36.

The N-side Y-capacitor busbar 42 has a main portion 42C, the N-side first busbar terminal 42A, and an N-side second busbar terminal 42B. The main portion 42C has a portion extending in the planar direction along a bottom surface of the N-type element storage portion 34B, and a portion extending in the thickness direction TD. The N-side Y-capacitor busbar 42 has two portions extending in the thickness direction TD. The two portions extending in the thickness direction TD are provided at each of the ends in the width direction WD and the depth direction DP of a portion extending in the planar direction along the bottom surface of the N-type element storage portion 34B.

The N-side first busbar terminal 42A is provided at a tip of a portion extending in the thickness direction TD from an end in the width direction WD. An N-side second busbar terminal 42B is provided at a tip of a portion extending in the thickness direction TD from the end in the depth direction DP. The N-side first busbar terminal 42A and the N-side second busbar terminal 42B both extend along the planar direction.

The coating resin 36 coats a portion extending along the bottom surface of the N-type element storage portion 34B and a part of the portions extending from the ends in the width direction WD and the depth direction DP. The remaining portions extending from the ends in the width direction WD and the depth direction DP, the N-side first busbar terminal 42A, and the N-side second busbar terminal 42B are exposed from the exposed surface 36A.

The N-side Y-capacitor element 32 includes an N-side first element terminal 32A connected to the N-side first busbar terminal 42A, and an N-side second element terminal 32B connected to the N-side GND terminal 52. The N-side first element terminal 32A and the N-side second element terminal 32B extend in the thickness direction TD away from the N-side Y-capacitor element 32. An end of the N-side first element terminal 32A and an end of the N-side second element terminal 32B are exposed from the exposed surface 36A.

The N-side first element terminal 32A exposed from the exposed surface 36A and the N-side first busbar terminal 42A are connected via the solder 102. The N-side second element terminal 32B exposed from the exposed surface 36A is connected to the N-side GND terminal 52 via the solder 102. The N-side GND terminal 52 is provided closer to the first opening end than the exposed surface 36A. It can also be said that the N-side first busbar terminal 42A is provided closer to the first storage space 141 than the exposed surface 36A. It can also be said that the N-side GND terminal 52 is provided closer to the first storage space 141 than the exposed surface 36A.

The N-side Y-capacitor busbar 42 is solder-connected to the N-side first element terminal 32A outside the coating resin 36. The N-side Y-capacitor busbar 42 is arranged so as to be covered with the coating resin 36 midway as it extends from a connecting portion with the N-side first element terminal 32A toward a connecting portion with the N-side high-voltage wire 10B.

The Y-capacitor 30 is provided above the wiring hole 138 with the exposed surface 36A facing the first opening end. The Y-capacitor 30 is provided above the wiring hole 138 such that the exposed surface 36A faces the front surface 136A or the first storage space 141 side. As described above, a portion of the P-side Y-capacitor busbar 41 and a portion of the N-side Y-capacitor busbar 42 are exposed from the exposed surface 36A.

The P-side Y-capacitor busbar 41 and the N-side Y-capacitor busbar 42 extend from the second storage space 142 to the first storage space 141 through the wiring hole 138. In the first storage space 141, the P-side second busbar terminal 41B, the P-side fastening member 100A, and the P-side distribution portion 83A are fastened to each other via the P-side fastening member 100A. In the first storage space 141, the N-side second busbar terminal 42B, the N-side high-voltage wire 10B, and the N-side distribution portion 83B are fastened together via the N-side fastening member 100B.

### <Y-Capacitor Case>

The specific configuration of the Y-capacitor case 33 will be described below. As described above, the Y-capacitor case 33 has two element storage portions 34 and the connecting portion 35. The connecting portion 35 is provided with a first through hole 35A penetrating therethrough in the thickness direction TD. The Y-capacitor 30 is provided to cover the wiring hole 138 so that the first through hole 35A and the fastening hole 139 overlap in the thickness direction TD.

An opening of the P-type element storage portion 34A has a substantially L-shape extending in the width direction WD and the depth direction DP when viewed in the thickness direction TD. One end of the L-shape is adjacent to the first through hole 35A. The P-type element storage portion 34A has an L-shape with a part extending in the width direction WD and the remainder of the L-shape extending in the depth direction DP. The P-side Y-capacitor element 31 is housed in a portion of P-type element storage portion 34A extending in the depth direction DP.

The P-side Y-capacitor element 31 is housed in a portion of the P-type element storage portion 34A extending in the depth direction DP. The P-side first element terminal 31A and the P-side second element terminal 31B are aligned in the depth direction DP. The P-side first element terminal 31A is further away from the fastening hole 139 than the P-side second element terminal 31B. A portion of the P-side Y-capacitor busbar 41 where the P-side second busbar terminal 41B is provided extends along a wall surface of the P-type element storage portion 34A. The wall surface is disposed at a position furthest away from the P-side first element terminal 31A in a portion of the P-type element storage portion 34A extending in the width direction WD.

An opening of the N-type element storage portion 34B has a substantially rectangular shape extending in the width direction WD when viewed in the thickness direction TD. One end of the rectangle in the width direction WD is adjacent to the first through hole 35A. The N-side Y-capacitor element 32 is housed in the N-type element storage portion 34B such that the N-side first element terminal 32A and the N-side second element terminal 32B are aligned in the width direction WD. The N-side first element terminal 32A is farther away from the fastening hole 139 than the N-side second element terminal 32B. A portion of the N-side Y-capacitor busbar 42 where the N-side second busbar terminal 42B is provided extends along a wall surface of the N-type element storage portion 34B. The wall surface extends along walls aligned in the depth direction DP in the N-type element storage portion 34B.

The connecting portion 35 is provided to connect a wall portion provided on the inner side of the P-type element storage portion 34A in the planar direction with a wall portion provided on the inner side of the N-type element storage portion 34B in the planar direction. The first through hole 35A is provided at a corner where the two wall portions of the connecting portion 35 are joined.

### <GND Busbar>

As described above, the GND busbar 50 has the P-side GND terminal 51, the N-side GND terminal 52, and the extension portion 53 connecting the P-side GND terminal 51 and the N-side GND terminal 52. The extension portion 53 has an overlapping portion 55 that overlaps with the connecting portion 35, a first connecting portion 56, and a second connecting portion 57. The first connecting portion 56 connects the overlapping portion 55 and the P-side GND terminal 51. The second connecting portion 57 connects the overlapping portion 55 and the N-side GND terminal 52. The overlapping portion 55 has the case connecting portion 54. The overlapping portion 55 extends along the connecting portion 35. The GND busbar 50 extends from the connecting portion between the P-side second element terminal 31B and the N-side second element terminal 32B toward the case connecting portion 54. The GND busbar 50 is arranged so that a part of the GND busbar 50 is covered with the coating resin 36.

The overlapping portion 55 extends in the planar direction so as to connect the first connecting portion 56 and the second connecting portion 57. A cross-sectional area of the overlapping portion 55 taken along a cross section perpendicular to an extension direction extending to connect the first connecting portion 56 and the second connecting portion 57 is defined as a first cross-sectional area. A cross-sectional area taken along a cross section perpendicular to an extension direction of the P-side GND terminal 51 and the N-side GND terminal 52 is defined as a second cross-sectional area. The first cross-sectional area is greater than the second cross-sectional area. The extension direction of the overlapping portion 55 that extends to connect the first connecting portion 56 and the second connecting portion 57 corresponds to a longitudinal direction of the overlapping portion 55. The extension direction of the P-side GND terminal 51 and the N-side GND terminal 52 corresponds to a longitudinal direction of the P-side GND terminal 51 and the N-side GND terminal 52.

The overlapping portion 55 is provided in the case 130. The overlapping portion 55 has the case connecting portion 54 that is connected to the case 130. The case connecting portion 54 has a second through hole 54A penetrating therethrough in the thickness direction TD. The second through hole 54A overlaps with the first through hole 35A and the fastening hole 139. The fastening member 100C passes through the first through hole 35A, the fastening hole 139, and the second through hole 54A. The GND busbar 50 is electrically connected to the case 130 via the fastening member 100C. The P-side second element terminal 31B of the P-side Y-capacitor element 31 is provided closer to the case connecting portion 54 than the P-side first element terminal 31A. The N-side second element terminal 32B of the N-side Y-capacitor element 32 is provided closer to the case connecting portion 54 than the N-side first element terminal 32A.

The first connecting portion 56 has a portion extending in the planar direction along the bottom surface of the P-type element storage portion 34A, and a portion extending in the thickness direction TD. The first connecting portion 56 has two portions extending in the thickness direction TD. The two portions extending in the thickness direction TD are provided at both ends in the depth direction DP of a portion extending in the planar direction along the bottom surface of the P-type element storage portion 34A. The P-side GND terminal 51 is provided at a tip of one of the two portions extending in the thickness direction TD. The overlapping portion 55 is provided at a tip of another one of the portions extending in the thickness direction TD.

The P-side GND terminal 51 and the overlapping portion 55 both extend in the planar direction. The first connecting portion 56 has a substantially U-shape when viewed in the width direction WD. A recessed portion of the U-shape is covered with the coating resin 36 and is fixed to an inner surface of the P-type element storage portion 34A. A portion of first connecting portion 56 that is covered with coating resin 36 faces the P-side Y-capacitor element 31 in the depth direction DP. Heat from the P-side Y-capacitor element 31 is easily transferred to the first connecting portion 56 via the coating resin 36.

The second connecting portion 57 is similar to the first connecting portion 56. The second connecting portion 57 has a portion extending in the planar direction along the bottom surface of the N-type element storage portion 34B, and a portion extending in the thickness direction TD. The second connecting portion 57 has two portions extending in the thickness direction TD. The portions extending in the thickness direction TD are provided at both ends in the width direction WD of a portion extending in the planar direction along the bottom surface of the N-type element storage portion 34B. The N-side GND terminal 52 is provided at a tip of one of the two portions extending in the thickness direction TD. The overlapping portion 55 is provided at a tip of another one of the two portions extending in the thickness direction TD.

The N-side GND terminal 52 and the overlapping portion 55 both extend in the planar direction. The portion of the second connecting portion 57 that is accommodated in the N-type element storage portion 34B has a substantially U-shape when viewed in the depth direction DP. A recessed portion of the U-shape is covered with the coating resin 36 and fixed to the inner surface of the N-type element storage portion 34B. A portion of the second connecting portion 57 that is covered with the coating resin 36 faces the N-side Y-capacitor element 32 in the depth direction DP. Heat from the N-side Y-capacitor element 32 is easily transferred to the second connecting portion 57 via the coating resin 36.

### <Actions And Effects>

In recent years, with an increase in switching speed in inverters and tightening of EMC standards, the FM band, which was not an issue before, is becoming an issue. There is a demand for reducing noise in this FM band. Therefore, in order to remove noise in the FM band, it is required to mount the Y-capacitor on the power converter. Generally, capacitors are required to be used at temperatures below their heat resistance, taking into consideration self-heating and heat dissipation. Y-capacitors are also required to be used at temperatures below their heat resistance. Of all the components mounted on the power converter, the Y-capacitor has the lowest heat resistance. For this reason, it has been necessary to devise a method and arrangement for mounting the Y-capacitor within the power converter.

The power converter 10 includes the power module 120, the smoothing capacitor 20, the Y-capacitor 30, and the case 130. The case 130 includes the frame 131 and the partition wall 136. The frame 131 extends in one direction and has a closed annular enclosure shape centered on an axis along the one direction. The partition wall 136 is provided inside the frame 131 and divides the storage space 140 inside the frame 131 into two. The storage space 140 is divided into the first storage space 141 and the second storage space 142 by the partition wall 136. The smoothing capacitor 20 and the power module 120 are housed in the first storage space 141. The Y-capacitor 30 is housed in the second storage space 142. The Y-capacitor 30 does not overlap with the smoothing capacitor 20 and the power module 120 in the thickness direction TD. The Y-capacitor 30 is arranged offset in the planar direction with respect to the smoothing capacitor 20 and the power module 120. This makes it easier to prevent the radiant heat from the power module 120 and the smoothing capacitor 20 from being transferred to the Y-capacitor 30.

The power converter 10 has the high-voltage wires 10A, 10B. The high-voltage wires 10A, 10B electrically connect the inverter 11, the smoothing capacitor 20, and the high-voltage battery 2 together. The Y-capacitor 30 has the Y-capacitor elements 31, 32 and the Y-capacitor busbars 41, 42. The wiring hole 138 is provided in the partition wall 136 so as to penetrate therethrough in the thickness direction TD. The Y-capacitor 30 is provided in the second storage space 142 so that the Y-capacitor busbars 41, 42 pass through the wiring hole 138. The high-voltage wires 10A, 10B and the Y-capacitor busbars 41, 42 are connected to each other at positions overlapping the wiring hole 138 in the first storage space 141 in the thickness direction TD. The high-voltage wires 10A, 10B and the Y-capacitor busbars 41, 42 are electrically and mechanically connected via the fastening members 100A, 100B.

According to this, during manufacturing, a tool can be passed through the wiring hole 138 to fasten the Y-capacitor busbars 41, 42 and the high-voltage wires 10A, 10B via the fastening members 100A. Furthermore, by making this wiring hole 138 a common hole for passing the Y-capacitor busbar 41, there is no need to form a hole in the partition wall 136 for passing the Y-capacitor busbar 41 therethrough, separate from the wiring hole 138. This tends to reduce the radiant heat from the power module 120 and the smoothing capacitor 20 from being transferred to the second storage space. The temperature rise of the Y-capacitor 30 is easily reduced.

The power converter 10 includes the high-voltage battery 2, the high-voltage wires 10A, 10B, and the high-voltage connector 81. The high-voltage connector 81 has the supply portion 82 and the distribution portion 83. The supply portion 82 is attached to the third wall portion 134 of the frame 131. The wiring hole 138 is formed in the partition wall 136 so as to be adjacent to a portion of the third wall portion 134 where the high-voltage connector 81 is provided.

The Y-capacitor 30 is provided in the second storage space 142 so as to cover the wiring hole 138. This makes it easier for noise attempting to enter the inside of the case 130 from the outside to be reduced by the Y-capacitor elements 31, 32 before it reaches the electrical components housed inside. Furthermore, since noise generated by switching is likely to be reduced by the Y-capacitor elements 31, 32, noise is likely to be prevented from escaping from the inside to the outside. Noise propagation to external devices is easily reduced.

The Y-capacitor 30 further includes the GND busbar 50, the Y-capacitor case 33, and the coating resin 36. The GND busbar 50 electrically connects the Y-capacitor elements 31, 32 to ground. The Y-capacitor case 33 has the Y-capacitor elements 31, 32 and the element storage portion 34. The coating resin 36 is provided on the element storage portion 34. The Y-capacitor elements 31, 32 and parts of the Y-capacitor busbars 41, 42 are covered with the coating resin 36.

The Y-capacitor 30 is provided in the second storage space 142 such that the exposed surface 36A faces the first storage space 141. The GND terminals 51, 52 are provided closer to the first storage space 141 in the thickness direction TD than the Y-capacitor elements 31, 32. This allows the radiant heat from the power module 120 and the smoothing capacitor 20 to be easily transferred to the case 130 via the GND busbar 50. This tends to reduce the transfer of the radiant heat from the power module 120 and the smoothing capacitor 20 to the Y-capacitor elements 31, 32.

The Y-capacitor 30 has two Y-capacitor elements 31, 32 and two Y-capacitor busbars 41, 42. The Y-capacitor case 33 has two element storage portions 34. The Y-capacitor element 31 and a part of the Y-capacitor busbar 41 are housed in one element storage portion 34A. The Y-capacitor element 32 and a part of the Y-capacitor busbar 42 are housed in another element storage portion 34B. The Y-capacitor case 33 further has the connecting portion 35 connecting the two element storage portions 34A, 34B. The extension portion 53 extending from the GND terminals 51, 52 of the GND busbar 50 extends along the connecting portion 35. The GND busbar 50 and the case 130 are electrically and thermally connected at the extension portion 53.

The P-side Y-capacitor element 31 and the N-side Y-capacitor element 32 are housed in respective element storage portions 34. This prevents thermal interference between the P-side Y-capacitor element 31 and the N-side Y-capacitor element 32. Furthermore, the GND busbar 50 and the case 130 are electrically and thermally connected to each other at the extension portion 53. Therefore, the thermal interference between the P-side Y-capacitor element 31 and the N-side Y-capacitor element 32 is effectively reduced.

The P-side Y-capacitor element 31 includes the P-side first element terminal 31A and the P-side second element terminal 31B. The N-side Y-capacitor element 32 includes the N-side first element terminal 32A and the N-side second element terminal 32B. The P-side second element terminal 31B is provided closer to the case connecting portion 54 than the P-side first element terminal 31A. The N-side second element terminal 32B is provided closer to the case connecting portion 54 than the N-side first element terminal 32A. This allows the heat from the P-side Y-capacitor element 31 and the N-side Y-capacitor element 32 to be efficiently dissipated to the GND busbar 50.

Also, the first cross-sectional area is greater than the second cross-sectional area. As a result, the area of the overlapping portion 55 that can dissipate heat to the case 130 is increased. As a result, the heat dissipation properties of the P-side GND terminal 51 and the N-side GND terminal 52 are improved. The temperature rise of the P-side GND terminal 51 and the N-side GND terminal 52 can be reduced.

The P-side Y-capacitor busbar 41 is soldered to the P-side first element terminal 31A outside the coating resin 36. The P-side Y-capacitor busbar 41 extends from a connecting portion with the P-side first element terminal 31A toward a connecting portion with the P-side high-voltage wire 10A. The P-side Y-capacitor busbar 41 is arranged so that a part of its length is covered with the coating resin 36. The N-side Y-capacitor busbar 42 is solder-connected to the N-side first element terminal 32A outside the coating resin 36. The N-side Y-capacitor busbar 42 extends from a connecting portion with the N-side first element terminal 32A toward a connecting portion with the N-side high-voltage wire 10B. The N-side Y-capacitor busbar 42 is arranged so that a part of the busbar is covered with the coating resin 36.

The GND busbar 50 is solder-connected to the P-side second element terminal 31B and the N-side second element terminal 32B outside the coating resin 36. The GND busbar 50 extends from the connecting portion between the P-side second element terminal 31B and the N-side second element terminal 32B toward the case connecting portion 54. The P-side GND terminal 51 is arranged so that a portion of the P-side GND terminal 51 is covered with the coating resin 36.

Even if vibration is transmitted from the second busbar terminals 41B, 42B to the Y-capacitor busbars 41, 42, a portion of the vibration is covered by the coating resin. Therefore, the transmission of vibration to the connecting portions with the Y-capacitor elements 31, 32 is reduced. Stress applied to the solder 102 connecting the Y-capacitor elements 31, 32 and the Y-capacitor busbars 41, 42 is reduced. Similarly, even if vibration is transmitted from the case connecting portion 54 to the GND busbar 50, a portion of the vibration is covered by the coating resin. Therefore, the transmission of vibration to the connecting portions with the Y-capacitor elements 31, 32 is reduced. Stress applied to the solder 102 connecting the Y-capacitor elements 31, 32 to the GND busbar 50 is reduced.

The GND busbar 50 has the P-side GND terminal 51, the N-side GND terminal 52, and the extension portion 53 connecting the P-side GND terminal 51 and the N-side GND terminal 52. The extension portion 53 has an overlapping portion 55 that overlaps with the connecting portion 35, a first connecting portion 56, and a second connecting portion 57. A portion of first connecting portion 56 that is covered with coating resin 36 faces the P-side Y-capacitor element 31 in the depth direction DP. A portion of the second connecting portion 57 that is covered with the coating resin 36 faces the N-side Y-capacitor element 32 in the depth direction DP. As a result, the heat from the Y-capacitor elements 31, 32 can be easily transferred to the GND busbar 50.

### Second Embodiment

FIG. 10 is a cross-sectional view illustrating a modification of a Y-capacitor 30. In a second embodiment, the element storage portions 34A, 34B are provided with a wall 37 rising from bottom portions. The wall 37 provided in the element storage portion 34A is provided between a portion of the P-side Y-capacitor busbar 41 covered with the coating resin 36 and the P-side Y-capacitor element 31. The wall 37 reduces heat transfer between the portion of the P-side Y-capacitor busbar 41 covered with the coating resin 36 and the P-side Y-capacitor element 31. Although not shown in the drawing, the wall 37 provided in the element storage portion 34B is provided between the portion of the N-side Y-capacitor busbar 42 covered with the coating resin 36 and the N-side Y-capacitor element 32. The wall 37 reduces heat transfer between the portion of the N-side Y-capacitor busbar 42 covered with the coating resin 36 and the N-side Y-capacitor element 32. Since the wall 37 is interposed between the Y-capacitor busbars 41, 42 and the capacitor elements 31, 32, it is sometimes referred to as an interposed wall 37. The interposed wall 37 prevents heat from being transferred from the Y-capacitor busbar 42 to the Y-capacitor elements 31, 32.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A power converter comprising:
an inverter configured to convert electric power supplied from a battery;
a smoothing capacitor configured to smooth electric current supplied from the battery;
a Y-capacitor having a Y-capacitor element configured to reduce noise; and
a case housing the inverter, the smoothing capacitor, and the Y-capacitor, wherein
the case includes a frame that opens in one direction and has a ring shape, and a partition wall that divides a storage space surrounded by the frame into two spaces in the one direction,
the partition wall and a part of the frame define a first storage space,
the partition wall and another part of the frame define a second storage space,
an electrical component including the inverter and the smoothing capacitor is provided in the first storage space,
the Y-capacitor is provided in the second storage space, and
the electrical component and the Y-capacitor are shifted in a planar direction perpendicular to the one direction so that the electrical component and the Y-capacitor do not overlap in the one direction.

2. The power converter according to claim 1 further comprising
a first wire electrically connected to the inverter, the smoothing capacitor, and the battery, wherein
the Y-capacitor further includes a second wire connected to the first wire,
the partition wall has a hole penetrating in the one direction,
the second wire passes through the hole, and
a connecting portion between the first wire and the second wire is provided at a position overlapping the hole in the first storage space.

3. The power converter according to claim 2 further comprising
a connector electrically connecting the first wire, the second wire, and the battery, wherein
the connector includes a supply portion to which the electric power is supplied from the battery, and a distribution portion connected to the first wire and the second wire in the first storage space,
the supply portion is provided on the frame,
the hole in the partition wall is formed at a position adjacent to a portion of the frame where the supply portion is provided, and
the Y-capacitor is provided in the second storage space and covers the hole.

4. The power converter according to claim 3, wherein
the Y-capacitor includes:
a GND busbar connecting the Y-capacitor element to ground via the case;
a Y-capacitor case having a storage portion storing the Y-capacitor element and a part of the second wire; and
a coating resin that covers the Y-capacitor element and the part of the second wire, wherein
the Y-capacitor is provided in the second storage space such that an exposed surface of the coating resin faces the first storage space, and
a connection terminal of the GND busbar that is connected to the Y-capacitor element is provided closer to the first storage space than the Y-capacitor element in the one direction.

5. The power converter according to claim 4, wherein
the Y-capacitor element is one of two Y-capacitors,
the second wire is one of two second wires,
the storage portion is one of two storage portions,
one of the Y-capacitor elements and one of the second wires are provided in one of the storage portions,
the other of the Y-capacitor elements and the other of the second wire are provided in the other of the storage portion,
the Y-capacitor case further includes a connecting portion that connects the two storage portions,
a part of an extension portion of the GND busbar extending from the connection terminal extends along the connecting portion, and
the extension portion is provided with a case connecting portion that is connected to the case.

6. The power converter according to claim 5, wherein
each of the two Y-capacitor elements includes a first element terminal connected to the second wire and a second element terminal connected to the GND busbar, and
the second element terminal is provided closer to the case connecting portion than the first element terminal.

7. The power converter according to claim 6, wherein
a cross-sectional area of the extension portion in a direction perpendicular to a longitudinal direction of the extension portion is larger than a cross-sectional area of the connection terminal in a direction perpendicular to a longitudinal direction of the connection terminal.

8. The power converter according to claim 7, wherein
the second wire is soldered to the first element terminal outside the coating resin,
the GND busbar is soldered to the second element terminal outside the coating resin,
a part of the second wire between a portion connected to the first element terminal and a portion connected to the first wire is disposed inside the coating resin, and
a part of the GND busbar between a portion connected to the second element terminal and the case connecting portion is disposed inside the coating resin.

9. The power converter according to claim 8, wherein
a part of the GND busbar that is covered with the coating resin faces the Y-capacitor element.

10. The power converter according to claim 9, wherein
the storage portion has an interposed wall between the Y-capacitor element and a portion of the second wire that is covered with the coating resin, and
the interposed wall has a property that reduces heat transfer between the Y-capacitor element and the second wire.
